(19) United States
(12) Patent Application Publication
(10) Pub. No.: US 2021/0139007 A1
(43) Pub. Date: May 13, 2021

(54) ENHANCED VEHICLE OPERATION

(71) Applicant: Ford Global Technologies, LLC, Dearborn, MI (US)

(72) Inventors: Lodewijk Wijffels, Northville, MI (US); Joshua Guerra, Farmington Hills, MI (US); Donald Bradfield, Ferndale, MI (US); Ashrit Das, Canton, MI (US); Bradford Fillion, Clawson, MI (US); William Gregory Suter, Farmington Hills, MI (US)

(73) Assignee: Ford Global Technologies, LLC, Dearborn, MI (US)

(21) Appl. No.: 16/679,417

(22) Filed: Nov. 11, 2019

(51) Int. Cl. B60T 8/1755; B60W 40/114; G05D 1/08; G05D 1/02; B60W 10/18; B60W 10/20

(52) U.S. Cl. CPC B60T 8/1755; B60W 40/114; G05D 1/0891; B60W 2520/14; B60W 10/18; B60W 10/20; G05D 1/0212

(57) ABSTRACT

A computer includes a processor and a memory, the memory storing instructions executable by the processor to input a current trajectory and a planned path for a vehicle to a state observer algorithm to obtain a target yaw rate, compare the target yaw rate to an actual yaw rate to determine one of an oversteer or an understeer condition, and apply brakes on one or more but less than all wheels of the vehicle based on determining the understeer or oversteer condition.

### BACKGROUND

A vehicle may operate autonomously or semi-autonomously, i.e., without input from a human operator to control some or all driving operations, e.g., some or all of steering, propulsion (e.g., throttle), and braking. The vehicle can include sensors to collect data of an environment surrounding the vehicle. A computer in the vehicle can use the data to operate the vehicle. For example, the computer can actuate one or more components such as a steering motor to follow a path autonomously or semi-autonomously.

### BRIEF DESCRIPTION OF THE DRAWINGS

FIG. 1 is a block diagram of an example system for operating a vehicle.

FIG. 2 is a block diagram of an example system for operating the vehicle along a path.

FIG. 3 is a plan view of the vehicle.

FIG. 4 is a block diagram of an example process for operating the vehicle.

### DETAILED DESCRIPTION

A computer includes a processor and a memory, the memory storing instructions executable by the processor to input a current trajectory and a planned path for a vehicle to a state observer algorithm to obtain a target yaw rate, compare the target yaw rate to an actual yaw rate to determine one of an oversteer or an understeer condition, and apply brakes on one or more but less than all wheels of the vehicle based on determining the understeer or oversteer condition.

The instructions can further include instructions to obtain a target heading angle to follow the planned path with the state observer algorithm and to apply the brakes to provide the target heading angle.

The instructions can further include instructions to obtain a target longitudinal torque to follow the planned path with the state observer algorithm and to apply the brakes to provide the target longitudinal torque.

The instructions can further include instructions to obtain the target yaw rate based on a speed of the vehicle.

The state observer algorithm can be one of a model predictive control algorithm, a linear-quadratic regulator algorithm, a full state feedback control algorithm, a partial state feedback control algorithm, or a pole placement algorithm.

The instructions can further include instructions to obtain a plurality of target steering wheel angles and to plan actuation of a steering motor to provide the target steering wheel angles.

The instructions can further include instructions to determine a difference between a target steering wheel angle and a current steering wheel angle and to obtain the target yaw rate based on the difference.

The instructions can further include instructions to apply one of the brakes on one of the wheels inside a turn path of the vehicle in the understeer condition.

The instructions can further include instructions to apply one of the brakes on one of the wheels outside a turn path of the vehicle in the oversteer condition.

The instructions can further include instructions to reduce output from a powertrain in the understeer condition.

A method includes inputting a current trajectory and a planned path for a vehicle to a state observer algorithm to obtain a target yaw rate, comparing the target yaw rate to an actual yaw rate to determine one of an oversteer or an understeer condition, and applying brakes on one or more but less than all wheels of the vehicle based on determining the understeer or oversteer condition.

The method can further include obtaining a target heading angle to follow the planned path with the state observer algorithm and applying the brakes to provide the target heading angle.

The method can further include obtaining a target longitudinal torque to follow the planned path with the state observer algorithm and applying the brakes to provide the target longitudinal torque.

The method can further include obtaining the target yaw rate based on a speed of the vehicle.

The method can further include obtaining a plurality of target steering wheel angles and to plan actuation of a steering motor to provide the target steering wheel angles.

The method can further include determining a difference between a target steering wheel angle and a current steering wheel angle and obtaining the target yaw rate based on the difference.

The method can further include applying one of the brakes on one of the wheels inside a turn path of the vehicle in the understeer condition.

The method can further include applying one of the brakes on one of the wheels outside a turn path of the vehicle in the oversteer condition.

The method can further include reducing output from a powertrain in the understeer condition.

A system includes a plurality of brakes, each brake on one of a plurality of wheels of a vehicle, means for inputting a current trajectory and a planned path for the vehicle to a state observer algorithm to obtain a target yaw rate, means for comparing the target yaw rate to an actual yaw rate to determine one of an oversteer or an understeer condition, and means for applying the brakes on one or more but less than all wheels of the vehicle based on determining the understeer or oversteer condition.

The system can further include means for obtaining a target heading angle to follow the planned path with the state observer algorithm and means for applying the brakes to provide the target heading angle.

The system can further include means for applying one of the brakes on one of the wheels inside a turn path of the vehicle in the understeer condition.

The system can further include means for applying one of the brakes on one of the wheels outside a turn path of the vehicle in the oversteer condition.

The system can further include means for reducing output from a powertrain in the understeer condition.

Further disclosed is a computing device programmed to execute any of the above method steps. Yet further disclosed is a vehicle comprising the computing device. Yet further disclosed is a computer program product, comprising a computer readable medium storing instructions executable by a computer processor, to execute any of the above method steps.

Electronic stability controllers actuate components to adjust actual operation of a vehicle according to planned operation of the vehicle. For example, the electronic stability controller can actuate a brake to move the vehicle toward a planned path. Electronic stability controllers typically plan actuation of one or more vehicle components based on parameters internally determined by the electronic stability controller. By using a virtual driving system to provide parameters normally determined by the electronic stability controller, the electronic stability controller can plan actuation of components such as a brake or a powertrain to operate the vehicle according to a planned path. That is, rather than determining parameters in real time and actuating components according to those parameters, the electronic stability controller can more smoothly transition the vehicle from an actual path to a planned path and/or maintain vehicle stability along the path by actuating the components over a planned period of time.

FIG. 1 illustrates an example system 100 for operating a vehicle 101. The system 100 includes a computer 105. The computer 105, typically included in the vehicle 101, is programmed to receive collected data 115 from one or more sensors 110. For example, vehicle 101 data 115 may include a location of the vehicle 101, data about an environment around a vehicle 101, data about an object outside the vehicle such as another vehicle, etc. A vehicle 101 location is typically provided in a conventional form, e.g., geo-coordinates such as latitude and longitude coordinates obtained via a navigation system that uses the Global Positioning System (GPS). Further examples of data 115 can include measurements of vehicle 101 systems and components, e.g., a vehicle 101 velocity, a vehicle 101 trajectory, etc.

The computer 105 is generally programmed for communications on a vehicle 101 network, e.g., including a conventional vehicle 101 communications bus such as a CAN bus, LIN bus etc., and or other wired and/or wireless technologies, e.g., Ethernet, WIFI, etc. Via the network, bus, and/or other wired or wireless mechanisms (e.g., a wired or wireless local area network in the vehicle 101), the computer 105 may transmit messages to various devices in a vehicle 101 and/or receive messages from the various devices, e.g., controllers, actuators, sensors, etc., including sensors 110. Alternatively or additionally, in cases where the computer 105 actually comprises multiple devices, the vehicle network may be used for communications between devices represented as the computer 105 in this disclosure. In addition, the computer 105 may be programmed for communicating with the network 125, which, as described below, may include various wired and/or wireless networking technologies, e.g., cellular, Bluetooth®, Bluetooth® Low Energy (BLE), wired and/or wireless packet networks, etc.

The data store 106 can be of any type, e.g., hard disk drives, solid state drives, servers, or any volatile or non-volatile media. The data store 106 can store the collected data 115 sent from the sensors 110.

Sensors 110 can include a variety of devices. For example, various controllers in a vehicle 101 may operate as sensors 110 to provide data 115 via the vehicle 101 network or bus, e.g., data 115 relating to vehicle speed, acceleration, position, subsystem and/or component status, etc. Further, other sensors 110 could include cameras, motion detectors, etc., i.e., sensors 110 to provide data 115 for evaluating a position of a component, evaluating a slope of a roadway, etc. The sensors 110 could, without limitation, also include short range radar, long range radar, LIDAR, and/or ultrasonic transducers.

Collected data 115 can include a variety of data collected in a vehicle 101. Examples of collected data 115 are provided above, and moreover, data 115 are generally collected using one or more sensors 110, and may additionally include data calculated therefrom in the computer 105, and/or at the server 130. In general, collected data 115 may include any data that may be gathered by the sensors 110 and/or computed from such data.

The vehicle 101 can include a plurality of vehicle components 120. In this context, each vehicle component 120 includes one or more hardware components adapted to perform a mechanical function or operation—such as moving the vehicle 101, slowing or stopping the vehicle 101, steering the vehicle 101, etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, or the like.

When the computer 105 partially or fully operates the vehicle 101, the vehicle 101 is an “autonomous” vehicle 101. For purposes of this disclosure, the term “autonomous vehicle” is used to refer to a vehicle 101 operating in a fully autonomous mode. A fully autonomous mode is defined as one in which each of vehicle propulsion, braking, and steering are controlled by the computer 105. A semi-autonomous mode is one in which at least one of vehicle propulsion, braking, and steering are controlled at least partly by the computer 105 as opposed to a human operator. In a non-autonomous mode, i.e., a manual mode, the vehicle propulsion, braking, and steering are controlled by the human operator.

The system 100 can further include a network 125 connected to a server 130 and a data store 135. The computer 105 can further be programmed to communicate with one or more remote sites such as the server 130, via the network 125, such remote site possibly including a data store 135. The network 125 represents one or more mechanisms by which a vehicle computer 105 may communicate with a remote server 130. Accordingly, the network 125 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

FIG. 2 is a block diagram of a system 200 for operating the vehicle 101 along a path. In this context, a “path” is a set of location coordinates along which the vehicle 101 is planned to travel. The path can be determined, as described below, according to a conventional navigation or path-planning algorithm that generates coordinates to define the path. The system 200 includes a virtual driver system (VDS) 205. The VDS 205 is one or more electronic control units (ECUs) that communicate with the computer 105 to operate the vehicle 101 in the autonomous and the semiautonomous modes. As used herein, an “electronic control unit” is a computing device including a processor and a memory that includes programming to control one or more components of the vehicle 101. The programming of the VDS 205 to operate the vehicle 101 in the autonomous and the semiautonomous modes can be performed, in whole or in part, with the computer 105.

The VDS 205 includes a path planner 210. The path planner 210 is programming of the VDS 205 that generates a path for the vehicle 101 as the vehicle 101 moves from an origin to a destination. The path planner 210 can be stored in a memory, e.g., of one or more ECUs of the VDS 205. The path planner 210 can be, e.g., a navigational algorithm that generates location coordinates for the vehicle 101 over time. As an example, the path planner 210 can determine the path with a path polynomial. The path polynomial y(x) is a model that predicts the path as a line traced by a polynomial equation. The path polynomial y(x) predicts the path for a predetermined upcoming distance x, by determining a lateral coordinate y, e.g., measured in meters:

y(x)=a₀+a₁x+a₂x²+a₃x³+ . . . +aₙxⁿ (1)

The coefficients aₙ can represent one or more characteristics of the path, e.g., for a Nth degree path polynomial, a₀ an offset, i.e., a lateral distance between the path and a reference point of the vehicle 101 at the upcoming distance x, a₁ through aₙ represent polynomial coefficients describing the path. Alternatively, the path polynomial can include a different number of terms, e.g., a second-degree polynomial, a fourth-degree polynomial, etc. In the present context, the “upcoming distance” x is a predetermined longitudinal distance in front of the vehicle 101 from a reference point of the vehicle 101 (e.g., a center point of the vehicle 101) at which the sensors 110 collect data 115 and the path planner 210 predicts the path. The upcoming distance x can be determined based on, e.g., a current speed of the vehicle 101, a predetermined time threshold, determined based on empirical simulation data, a detection range of the sensors 110, etc. The time threshold can be, e.g., 1 second. The path polynomial can include one or more Bezier curves, i.e., polynomial functions that each represent a disjoint subset of points representing the path, and that taken together, represent the entire set of points representing the path. Bezier curves can be constrained to be continuously differentiable and have constraints or limits on the permitted derivatives, e.g. limits on the rates of change, with no discontinuities. Bezier curves can also be constrained to match derivatives with other Bezier curves at boundaries, providing smooth transitions between subsets. Constraints on Bezier curves can make a vehicle path polynomial a steerable path polynomial by limiting the rates of longitudinal and lateral accelerations required to pilot a vehicle along the vehicle path polynomial, where braking torque and powertrain torque are applied as negative and positive longitudinal accelerations and clockwise and counter clockwise steering torque are applied as right and left lateral accelerations. By determining lateral and longitudinal accelerations to achieve predetermined target values within predetermined constraints within predetermined numbers of time periods, the vehicle path polynomial can be constrained to provide a vehicle path polynomial can be operated upon by the VDS 205 without exceeding limits on lateral and longitudinal accelerations.

The VDS 205 includes a path follower 215. The path follower 215 is programming of the VDS 205 for following the path planned by the path planner 210. The path follower 215 can be stored on one or more of the ECUs of the VDS 205. The path follower 215 determines parameters of the vehicle 101 that, if met, would move the vehicle 101 along the path. For example, the path follower 215 can determine a speed, a longitudinal torque, a heading angle, a yaw rate, a steering wheel angle, etc.

The system 200 includes an electronic stability controller (ESC) 220. The electronic stability controller 220 is an ECU separate from the VDS 205 that actuates a brake 225 and/or a powertrain 230. The ESC actuates the brake 225 and/or the powertrain 230 to follow the path from the path follower 215 and/or maintain vehicle stability along the path. The electronic stability controller 220 communicates with the VDS 205, the brake 225, and the powertrain 230 over the network 125. The electronic stability controller 220 determines a current yaw rate of the vehicle 101 and actuates the brake 225 and/or the powertrain 230 to adjust the yaw rate to follow the path, as described below.

The path follower 215 determines the plurality of parameters with a state observer algorithm. In this context, a “state observer algorithm” is a control algorithm that outputs one or control parameters based on inputs of one or more states. The state observer algorithm can be expressed in a set of equations:

x(k+1)=Ax(k)+Bu(k) (1)

y(k)=Cx(k)+Du(k) (2)

where x represents one or more states of the vehicle 101 (such as velocity, yaw rate, and heading angle as described below), u represents a controlled output (such as a torque request, a steering request, etc.), y is an observed output, k is an index indicating a current value of x, u, and A, B, C, D are factors that correlate the states x and the controlled output u to the observed output y according to the specific system (such as a vehicle 101) represented by the state observer algorithm. The state observer algorithm can be, e.g., a model predictive control algorithm, a linear-quadratic regulator algorithm, a full state feedback control algorithm, a partial state feedback control algorithm, or a pole placement algorithm.

In the example of FIGS. 2-3, the state observer algorithm can be a model predictive control (MPC) algorithm. The MPC algorithm is a state observer algorithm that minimizes a cost function for one or any of a lateral velocity V, a yaw rate \dot{ψ}, a heading angle ψ, a lateral offset e, and a road wheel angle ϕ for a specific portion of the upcoming path. The path follower 215 determines a target yaw rate \dot{ψ}, a target heading angle ψ, a target road wheel angle ϕ, and a target longitudinal torque τ subject to predetermined constraints. The path follower 215 inputs the planned path from the path planner 210 and data 115 indicating a current trajectory of the vehicle 101 to the MPC algorithm to the cost function to determine weights for each parameter that minimize the cost function. In this context, a “trajectory” is a set of data 115 describing motion of the vehicle 101, including but not limited to the lateral velocity V, the heading angle ψ, the road wheel angle ϕ, etc. The “current trajectory” is the trajectory at a specific time at which the data 115 are collected and from which the path planner 210 plans the path. In this example, the current trajectory includes a current lateral velocity V, a current yaw rate \dot{ψ}, a current heading angle ψ, a current lateral offset e, and a current road wheel angle ϕ. The path follower 215 uses the weights to determine a target road wheel angle ϕ and a target steering wheel angle α that is the target road wheel angle ϕ multiplied by a steering ratio of the vehicle 101. For each portion of the path, the path follower 215 can input the weights from the MPC and the portion of the path to, for example a conventional vehicle kinematic model such as a vehicle dynamics model that outputs target values for the heading angle ψ, yaw rate \dot{ψ}, road wheel angle ϕ, and the longitudinal torque τ, a bicycle model, a full vehicle model, etc.

The path follower 215 can determine a target heading angle ψ. The “heading angle” is an angle between a current trajectory of the vehicle 101 and a track direction of the vehicle 101. A “track direction” is an axis defined by a line extending through a current position of the vehicle 101 and a position of the vehicle 101 at the most recent previous measurement of the position of the vehicle 101. The computer 105 can use the model predictive control algorithm to obtain a target heading angle ψ, i.e., a heading angle ψ that would move the vehicle 101 to the planned path. The path follower 215 can send the target heading angle ψ to the ESC 220 to actuate components 120 to attain the target heading angle ψ. For example, as described below, the ESC 220 can apply a brake 120 to provide the target heading angle ψ.

The path follower 215 can determine a target yaw rate \dot{ψ} to follow the path. The “yaw rate” \dot{ψ} is the time rate of change of the heading angle. The path follower 215 inputs the planned path from the path planner 210 and data 115 indicating a current trajectory of the vehicle 101 to the model predictive control algorithm and vehicle kinematic model to obtain the target yaw rate \dot{ψ}, as described above. For example, the model predictive control algorithm can determine the target yaw rate \dot{ψ} based on a speed of the vehicle 101. The path follower 215 can determine the target yaw rate \dot{ψ} by determining a difference between a target steering wheel angle α, as described below, and a current steering wheel angle α and inputting the difference to the kinematic model. The kinematic model can determine the target yaw rate \dot{ψ} as the yaw rate \dot{ψ} generated by changing the current steering wheel angle α to the target steering wheel angle α.

The path follower 215 can determine a target longitudinal torque τ. The longitudinal torque τ is a torque that, when applied to a wheel, moves the wheel to follow the planned path. The path follower 215 can obtain the target longitudinal torque τ to follow the planned path with the MPC and the vehicle kinematic model, as described above. The ESC 220 can apply the brake 225 to provide the target longitudinal torque r to turn the vehicle 101 to the planned path.

The path follower 215 can determine a target lateral offset e. The “lateral offset” is a lateral distance between a reference point of the vehicle 101, e.g., a center point of the vehicle 101, and the planned path. That is, the lateral offset e is the distance from the planned path that the vehicle 101 attains to follow the path. The path follower 215 can obtain the target lateral offset e with the MPC and the vehicle kinematic model, as described above. The ESC 220 can apply the brake 225 and/or the powertrain 230 to attain the target lateral offset e.

The path follower 215 can determine a target steering wheel angle α. The “steering wheel angle” is the angle of a steering wheel relative to a neutral position. The steering wheel angle α is the road wheel angle ϕ, described above, multiplied by a steering ratio. The computer 105 can plan actuation of a steering motor 120 to provide the target steering wheel angles α to follow the planned path.

The path follower 215 can obtain a plurality of the target parameters described above for an upcoming portion of the path. For the portion of the planned path input to the MPC, the path follower 215 can divide the planned path into a plurality of segments, each segment associated with a timestep within a period of time. That is, the path follower 215 can associate a period of time (e.g., 10 seconds) to the upcoming portion of the path (e.g., 200 meters) and determine target parameters for each timestep (e.g., 0.1 seconds) within the period of time. For each timestep, the path follower 215 can obtain respective target parameters, and the ESC 220 can plan actuation of components 120 according to the target parameters. For example, the path follower 215 can obtain a plurality of target yaw rates \dot{ψ} and the ESC 220 can plan actuation of the brakes 225 and/or the powertrain 230 to provide the target yaw rates \dot{ψ}.

The ESC 220 receives the parameters from the VDS 205. As described above, the path follower 215 of the VDS 205 can transmit parameters determined by the MPC and the kinematic model over the network 125 to the ESC 220. Upon receiving the parameters, the ESC 220 can plan actuation of the brakes 225 and the powertrain 230 to attain the target parameters.

The ESC 220 can identify one of an oversteer condition or an understeer condition based on the comparison of the target yaw rate \dot{ψ} to the actual yaw rate \dot{ψ}. The vehicle 101 is in an “oversteer” condition when the actual yaw rate \dot{ψ} multiplied by the sign of the target yaw rate is greater than the absolute value of the target yaw rate \dot{ψ} by at least a yaw rate threshold or the target yaw rate \dot{ψ} is zero and the actual yaw rate \dot{ψ} does not equal zero, causing the vehicle 101 to steer more than required to follow the path. The vehicle 101 is in an “understeer” condition when the actual yaw rate \dot{ψ} multiplied by the sign of the target yaw rate is less than the absolute value of the target yaw rate \dot{ψ} by at least the yaw rate threshold, causing the vehicle 101 to steer less than required to follow the path. Upon determining the condition, the ESC 220 can actuate the brake 225 and/or the powertrain 230 to attain the target yaw rate \dot{ψ}. The yaw rate threshold can be a predetermined value stored in the data store 106 and/or the server 130. The yaw rate threshold can be determined based on empirical testing and/or virtual simulation of turning vehicles 101 in understeer and oversteer conditions. The empirical testing can include operating vehicles 101 in oversteer and understeer conditions and collecting data about the actual yaw rates \dot{ψ} required to cause the oversteer and understeer conditions. That is, the yaw rate threshold can be a minimum yaw rate \dot{ψ} of the empirical testing data that caused an understeer condition or an oversteer condition.

FIG. 3 is a plan view of the vehicle 101. The vehicle 101 has a plurality of wheels 300. Each wheel has a brake 225. Each brake 225 slows or stops rotation of its respective wheel 300. In the example of FIG. 3, the vehicle 101 includes four wheels 300a, 300b, 300c, 300d and four corresponding brakes 225a, 225b, 225c, 225d. As described below, the ESC 220 can actuate at least one but fewer than all of the brakes 225a, 225b, 225c, 225d to attain the target yaw \dot{ψ} rate.

The vehicle 101 defines a turn path 305 when in a turn. The turn path 305 is a predicted path of the vehicle 101 when turning at the yaw rate \dot{ψ}. Two of the wheels 300 are “inside” the turn path 305 when a straight line from the wheels 300 in a vehicle-forward direction would intersect the turn path 305. Two of the wheels 300 are “outside” the turn path 305 when a straight line from the wheels 300 in a vehicle-forward direction would not intersect the turn path 305. That is, the wheels 300 inside the turn path 305 are interior to a curve defined by the turn path 305 and the wheels 300 outside the turn path 305 are exterior to the curve defined by the turn path 305. In the example of FIG. 3, the wheels 300a and 300b are inside the turn path 305 and the wheels 300c and 300d are outside the turn path 305.

The computer 105 can actuate one or more, but less than all, of the brakes 225a, 225b, 225c, 225d upon determining the understeer or oversteer condition. As described above, in the understeer condition, the current yaw rate \dot{ψ} would not move the vehicle 101 along the turn path 305, and the ESC 220 should increase the yaw rate \dot{ψ}. The ESC 220 can actuate the brakes 225 of wheels 300 inside the turn path 305 to increase the yaw rate \dot{ψ}. That is, in the example of FIG. 3, the ESC 220 can actuate one or both of the brakes 225a, 225b of the wheels 300a, 300b to increase the yaw rate \dot{ψ} to steer the vehicle 101 to the turn path 305. In the oversteer condition, the ESC 220 can actuate one or both of the brakes 225c, 225d of the wheels 300c, 300d outside the turn path 305 to decrease the yaw rate \dot{ψ}, steering the vehicle 101 to the turn path 305. By actuating less than all of the brakes 225, the ESC 220 can cause the vehicle 101 to turn toward the turn path 305.

FIG. 4 is a block diagram of an example process 400 for operating a vehicle 101. The process 400 begins in a block 405, in which a virtual driver system (VDS) 205 determines a path with a path planner 210. As described above, the path planner 210 generates a path for the vehicle 101 to follow from an origin to a destination.

Next, in a block 410, a path follower 215 of the VDS 205 determines a target yaw rate \dot{ψ} for an upcoming period of time to follow the path. The path follower 215 can input the planned path from the path planner 210 and data 115 about a current trajectory of the vehicle 101 is following to a state observer algorithm such as a model predictive control algorithm to determine a plurality of parameters to follow the planned path. The parameters include the target yaw rate \dot{ψ}. The parameters can include, e.g., a target steering wheel angle α, a speed V, a heading angle ψ, a longitudinal torque τ, etc. The path follower 215 determines the parameters for each of a plurality of timestamps corresponding to segments within an upcoming portion of the path. That is, the path follower 215 determines a plurality of target parameters, e.g., a plurality of target yaw rates \dot{ψ}, to follow the planned path.

Next, in a block 415, the VDS 205 transmits the target parameters, including the target yaw rates \dot{ψ}, to an electronic stability controller (ESC) 220. As described above, the ESC 220 communicates with a brake 225 and a powertrain 230 to move the vehicle 101 according to the target parameters. The ESC 220 can receive the target parameters from the VDS 205 over the network 125.

Next, in a block 420, the ESC 220 actuates at least one of the brake 225 or the powertrain 230 to achieve the target yaw rates \dot{ψ}. For example, in an understeer condition as described above, the ESC 220 can actuate a brake 225 corresponding to a wheel 300 inside a turn path to increase the actual yaw rate \dot{ψ} of the vehicle 101 to the target yaw rate \dot{ψ} of the vehicle 101.

Next, in a block 425, the computer 105 determines whether to continue the process 400. For example, the computer 105 can determine not to continue the process 400 upon reaching the end of the path, i.e., the destination. If the computer 105 determines to continue, the process 400 returns to a block 405. Otherwise, the process 400 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computing devices discussed herein, including the computer 105 and server 130, include processors and memories, the memories generally each including instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computer 105 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 400, one or more of the steps could be omitted, or the steps could be executed in a different order than shown in FIG. 4. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

What is claimed is:

1. A system, comprising a computer including a processor and a memory, the memory storing instructions executable by the processor to:
input a current trajectory and a planned path for a vehicle to a state observer algorithm to obtain a target yaw rate;
compare the target yaw rate to an actual yaw rate to determine one of an oversteer or an understeer condition; and
apply brakes on one or more but less than all wheels of the vehicle based on determining the understeer or oversteer condition.

2. The system of claim 1, wherein the instructions further include instructions to obtain a target heading angle to follow the planned path with the state observer algorithm and to apply the brakes to provide the target heading angle.

3. The system of claim 1, wherein the instructions further include instructions to obtain a target longitudinal torque to follow the planned path with the state observer algorithm and to apply the brakes to provide the target longitudinal torque.

4. The system of claim 1, wherein the instructions further include instructions to obtain the target yaw rate based on a speed of the vehicle.

5. The system of claim 1, wherein the state observer algorithm is one of a model predictive control algorithm, a linear-quadratic regulator algorithm, a full state feedback control algorithm, a partial state feedback control algorithm, or a pole placement algorithm.

6. The system of claim 1, wherein the instructions further include instructions to obtain a plurality of target steering wheel angles and to plan actuation of a steering motor to provide the target steering wheel angles.

7. The system of claim 1, wherein the instructions further include instructions to determine a difference between a target steering wheel angle and a current steering wheel angle and to obtain the target yaw rate based on the difference.

8. The system of claim 1, wherein the instructions further include instructions to apply one of the brakes on one of the wheels inside a turn path of the vehicle in the understeer condition.

9. The system of claim 1, wherein the instructions further include instructions to apply one of the brakes on one of the wheels outside a turn path of the vehicle in the oversteer condition.

10. The system of claim 1, wherein the instructions further include instructions to reduce output from a powertrain in the understeer condition.

11. A method, comprising:
inputting a current trajectory and a planned path for a vehicle to a state observer algorithm to obtain a target yaw rate;
comparing the target yaw rate to an actual yaw rate to determine one of an oversteer or an understeer condition; and
applying brakes on one or more but less than all wheels of the vehicle based on determining the understeer or oversteer condition.

12. The method of claim 11, further comprising obtaining a target heading angle to follow the planned path with the state observer algorithm and applying the brakes to provide the target heading angle.

13. The method of claim 11, further comprising applying one of the brakes on one of the wheels inside a turn path of the vehicle in the understeer condition.

14. The method of claim 11, further comprising applying one of the brakes on one of the wheels outside a turn path of the vehicle in the oversteer condition.

15. The method of claim 11, further comprising reducing output from a powertrain in the understeer condition.

16. A system, comprising:
a plurality of brakes, each brake on one of a plurality of wheels of a vehicle;
means for inputting a current trajectory and a planned path for the vehicle to a state observer algorithm to obtain a target yaw rate;
means for comparing the target yaw rate to an actual yaw rate to determine one of an oversteer or an understeer condition; and
means for applying the brakes on one or more but less than all wheels of the vehicle based on determining the understeer or oversteer condition.

17. The system of claim 16, further comprising means for obtaining a target heading angle to follow the planned path with the state observer algorithm and means for applying the brakes to provide the target heading angle.

18. The system of claim 16, further comprising means for applying one of the brakes on one of the wheels inside a turn path of the vehicle in the understeer condition.

19. The system of claim 16, further comprising means for applying one of the brakes on one of the wheels outside a turn path of the vehicle in the oversteer condition.

20. The system of claim 16, further comprising means for reducing output from a powertrain in the understeer condition.
